(19) United States
(12) Patent Application Publication
(10) Pub. No.: US 2010/0274668 A1
(43) Pub. Date: Oct. 28, 2010

(54) DOMAIN SUB-LEASING AND PARAMETER-BASED CONTENT DELIVERY SYSTEM

(76) Inventors: Frank Langston, Memphis, TN (US); Camilo Acosta, Chevy Chase, MD (US)

Correspondence Address: COOLEY LLP;ATTN: Patent Group, Suite 1100, 777 - 6th Street, NW, WASHINGTON, DC, 20001, US

(21) Appl. No.: 12/767,879

(22) Filed: Apr. 27, 2010

Related U.S. Application Data
(60) Provisional application No. 61/173,383, filed on Apr. 28, 2009.

(51) Int. Cl. G06F 15/16; G06Q 30/00

(52) U.S. Cl. 705/14.55; 709/203

(57) ABSTRACT

In one embodiment, a processor-readable medium can store code representing instructions configured to cause a processor to receive a website address from a requesting device. A device identifier associated with the requesting device can be received. A geographic location associated with the requesting device can be determined based at least in part on the device identifier. A domain sublease record can be identified based at least in part on the geographic location and the website address. A web content portion associated with the domain sublease record can be sent to the requesting device.

### PRIORITY CLAIM

The present application claims priority to U.S. provisional application No. 61/173,383 entitled “Domain Sub-leasing and Parameter-based Content Delivery System,” filed on Apr. 28, 2009, which is hereby incorporated by reference herein in its entirety.

### BACKGROUND

Embodiments described herein relate generally to domain subleasing, and more particularly to methods and apparatus for geographic- and demographic-based subleasing of Internet domain names.

The number of registered Internet domain names around the world has grown exponentially since the mid-1990s. This growth relates to a severe shortage of brief, effective domain names in a system where such high-value keyword domain names are in finite supply.

Many of the services or products which high-value keyword domain names describe are local in nature, but the entire domain name system is only available at the global level. This dichotomy has led to a proliferation of domain name “squatters” or “domain parkers” that acquired generic domain names describing important services. These “parked” pages are of little utility to the public and often serve solely as poorly configured advertising portals.

The acquisition of any single domain name describing a general service is out of the reach of most local and regional businesses to whom the domain name would be most valuable. Take for example “www.roofrepair.com.” If a regional roofing company in Houston were to have the website of “www.roofrepair.com” it would be directly useful to the company and to citizens in the Houston area in need of roofing services. It would be of neutral, if not negative, utility to consumers of roofing services in Los Angeles to go to “www.roofrepair.com” and find the website of a Houston service provider. It is just as useless for consumers in Houston and Los Angeles to visit a parked advertising site at “www.roofrepair.com” that has advertisements for roofers around the country or even completely unrelated advertisements.

Some parked advertising sites do provide advertisements for local service providers, often alongside other providers from outside the area or unrelated advertisements. These parked sites can be confusing and intimidating to consumers. Among others, the disclosed invention addresses the problem of local service providers being forced to operate in a domain name system that is global in nature.

The disclosed invention is not limited to leasing generic domain names that are local in nature, however; it can also be used to facilitate a variety of other improvements that include, but are not limited to, connecting domain owners and companies of all sizes around the world attempting to reach specific geographic markets of any size—from small towns, to cities, to entire continents. For example, a large company in India may sell train tickets and want to acquire “www.traintickets.com” for users in India. If the U.S. company that owns “www.traintickets.com” has no presence in or plans to expand to India, it may therefore be willing to lease “www.traintickets.com” for the Indian market. The disclosed invention allows for the execution of that transaction and the resulting increased efficiencies in the domain name marketplace.

The disclosed invention also facilitates the leasing of a domain name for a network of geographies with specific demographic characteristics. For example, a company that specializes in high-end jewelry could lease the domain name “www.diamondring.com” for specific geographies at the neighborhood level with average household incomes above $200,000. A different company specializing in budget jewelry could lease “www.diamondring.com” for neighborhoods with average household incomes less than $50,000.

In some embodiments, the invention can be offered as a service to companies that have a broad geographical presence but wish to target unique websites to each market they serve while maintaining the brand equity they have built in the domain name they are using. For example, a national chain of fitness clubs that owns “www.awesomefitness.com” may wish to offer differentiated website content for the Florida and Wisconsin markets while using the same domain name. By use of the disclosed invention, the national chain can configure routing and content settings so that in winter, those accessing the domain from Florida see a site focused on outdoor fitness, while those accessing the domain from Wisconsin see indoor-focused activities. The disclosed invention makes this evolution of the Internet possible.

Furthermore, a business or other organization with multiple physical or virtual office locations may use the invention as a service that allows their employees or others to directly receive differentiated website content relevant to the nearest office.

The structure of the Internet Protocol (“IP”) system makes it possible to determine an Internet user's regional geographic location with relative accuracy. This determination is typically made using the IP address of the computing or other device employed by that user to access the Internet. The disclosed invention builds on that capability to improve the Internet user's experience by automatically and directly delivering the web content of highly relevant local service providers based on his or her geographic location. In some embodiments, local service providers can lease or own a geographically defined portion of a domain name. In some embodiments, whenever an Internet user in the geographically defined area visits a domain name (such as “www.roofrepair.com”), that Internet user will be routed directly to the page that is leased or owned by the relevant local service provider.

In some embodiments, a service provider can elect whether the disclosed system should show an Internet user content associated with a generic URL, a geo-identified URL, or the service provider's branded URL. For example, when an Internet user in Houston types in “www.roofrepair.com”, the system can, based on the Houston service provider's preference, directly route the Internet user's computer to a page containing that service provider's content and labeled with the URL “www.roofrepair.com,” “www.houston.roofrepair.com,” or “www.smithbrothersroofingservice.com.” The disclosed invention thus provides an improved user experience and remedies the imbalanced relationship between local general service providers and globalized domain names.

In one preferred embodiment of the system, the system receives input from an Internet user's direct navigation, (i.e., input received when the user types, for example, “www.roofrepair.com” into the Uniform Resource Locator (URL) bar of a web browser), from a Search Engine Results Page (SERP), or from any other method of receiving a URL either directly or via an online link. The system can receive the URL input via, for example, a wired or wireless network, such as a LAN, a WAN, an Intranet, or the Internet. In some embodiments, a server included in the system can detect, to the extent possible, the current geographic location and/or region of the computer or device requesting the URL. For example, in some embodiments, the server can receive, in addition to the requested URL, an IP address of the requesting computer or device, and, using lookup tables or another method, determine a geographic region location of the requesting computer or device. In some embodiments, the requesting computer or device can be a personal computer, a portable device such as a personal digital assistant (PDA), a smartphone, a cellular telephone, a tablet computing device, or other computerized device capable of accessing content on a network such as the Internet. If the server determines that a service provider in the determined geographic region has opted to lease or buy the accessed domain name for that region, then the system can automatically direct the requesting computer or device to a website of that provider's choosing. In some embodiments, if the server determines that no general service provider leases or owns the domain name for that region, it can route the requesting computer or device to a generic website similar to the existing parked advertising websites, to the content of the service provider that has leased the domain name for the nearest geographic region, or to a site offering the Internet user the chance to lease the domain name for themselves.

In some embodiments, the server can be configured to direct the requesting computer or device to a generic landing page if the location of the requesting computer or device cannot be determined. In some embodiments, the content of the generic landing page can include a prompt asking the Internet user to input his or her geographic location. In such embodiments, the system can, upon receipt of the input geographic location information, immediately direct the requesting computer or device to the appropriate website content for its current locality.

### SUMMARY

In one embodiment, a processor-readable medium can store code representing instructions configured to cause a processor to receive a website address from a requesting device. A device identifier associated with the requesting device can be received. A geographic location associated with the requesting device can be determined based at least in part on the device identifier. A domain sublease record can be identified based at least in part on the geographic location and the website address. A web content portion associated with the domain sublease record can be sent to the requesting device.

### BRIEF DESCRIPTION OF THE DRAWINGS

FIG. 1 is a schematic block diagram that illustrates exemplary components of a parameter-based domain leasing system.

FIG. 2 is a flow chart that outlines exemplary steps for the provisioning of a parameter-based domain leasing system.

FIG. 3 is a flow chart outlining an exemplary process for the intake of one or more domain names from an independent domain owner into a parameter-based domain leasing system inventory.

FIG. 4 is a schematic block diagram that illustrates a partitioning of an internal host server associated with a domain leasing system based on likely parameters.

FIG. 5 is a flowchart that outlines steps for the creation of a parameter-based lease in a domain leasing system.

FIG. 6 is a schematic block diagram that illustrates a parameter database organizing the location of content on host servers based on customer-selected parameters in a parameter-based domain leasing system.

FIG. 7 is a flowchart outlining a process by which an Internet user accesses content associated with a domain name within a parameter-based domain leasing system.

FIG. 8 is a schematic block diagram that illustrates components of an allocation server portion of a parameter-based domain leasing system.

FIG. 9 is a graphical illustration that illustrates a graphical interface that allows an Internet user to access content of a domain customer other than that to which the Internet user has been automatically directed by an allocation server associated with a parameter-based domain leasing system.

### DETAILED DESCRIPTION

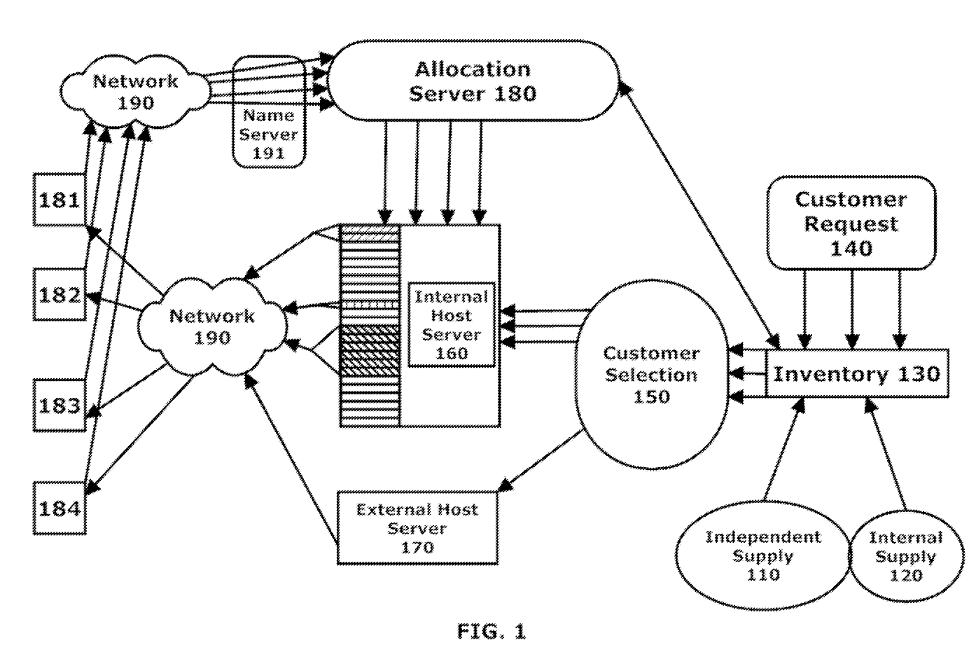

FIG. 1 is a schematic block diagram that illustrates exemplary components of a parameter-based domain leasing system. The leasing system takes in domain name inventory from independent domain owner(s) 110 and/or internally supplied domain names 120. In some embodiments, the leasing system can receive the domain names via, for example, another computerized device or system. In such embodiments, the leasing system can receive the domain names via a network, such as a LAN, WAN, or the Internet, via user input directly to the system, and/or via a processor-readable storage medium such as an optical disc, flash memory drive, and the like. Independently supplied domain names 110 include domain names that are licensed by a domain registrant (owner) from an authorized domain registrar, as determined by a certifying organization such as the Internet Corporation for Assigned Names and Numbers (ICANN), or any similar or successor organization with said authority. For purposes of this invention, a domain registrant may be referred to as a “domain name registrant”, “domain owner”, “domain supplier” or “domain holder”. Domain names include, but are not limited to, any string of characters in the alphabet or combination of alphabets from any language and may end in any existing or future Top Level Domain (TLD), such as “.com”, “.net”, “.in”, etc. It is also foreseeable that domain names will one day not require a TLD and, as such, would also be considered domain names for the purposes of the invention.

Internally supplied domain names 120 include domain names where the domain owner is the provider of the system in FIG. 1. These domain names may be obtained through acquisition of unregistered domain names, purchase of domain names from independent domain owners, certification by the provider of the system as a domain registrar, or any other means feasible for the acquisition of domain names.

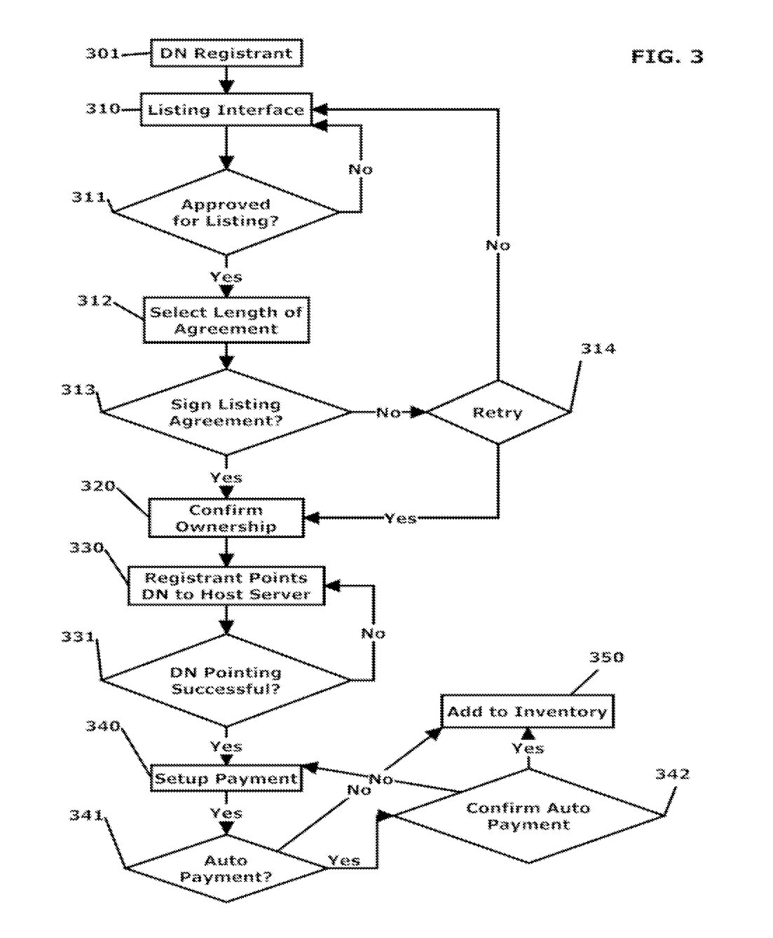

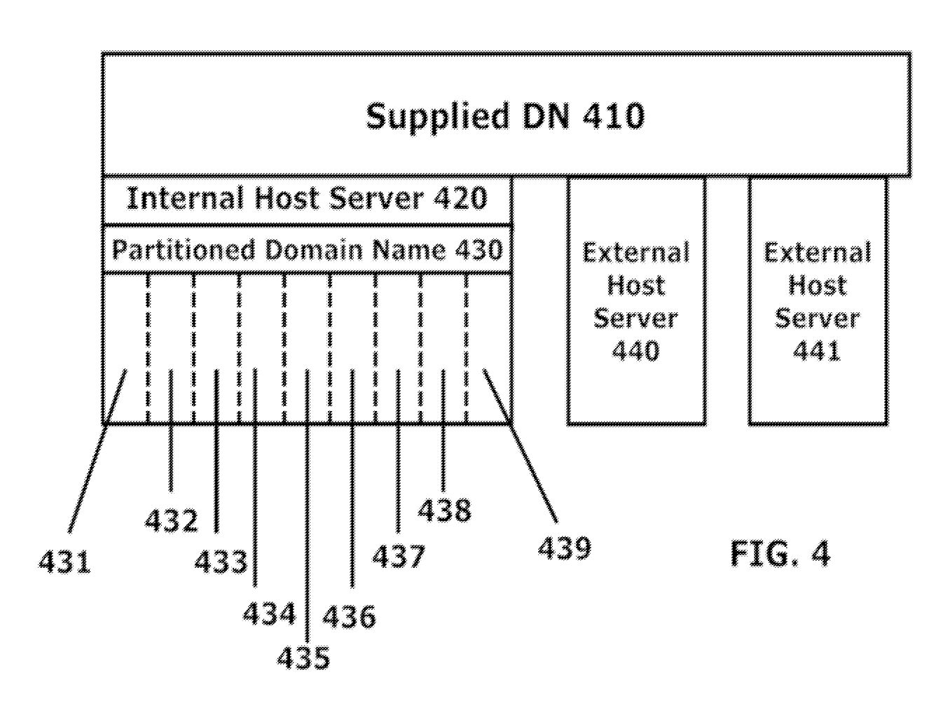

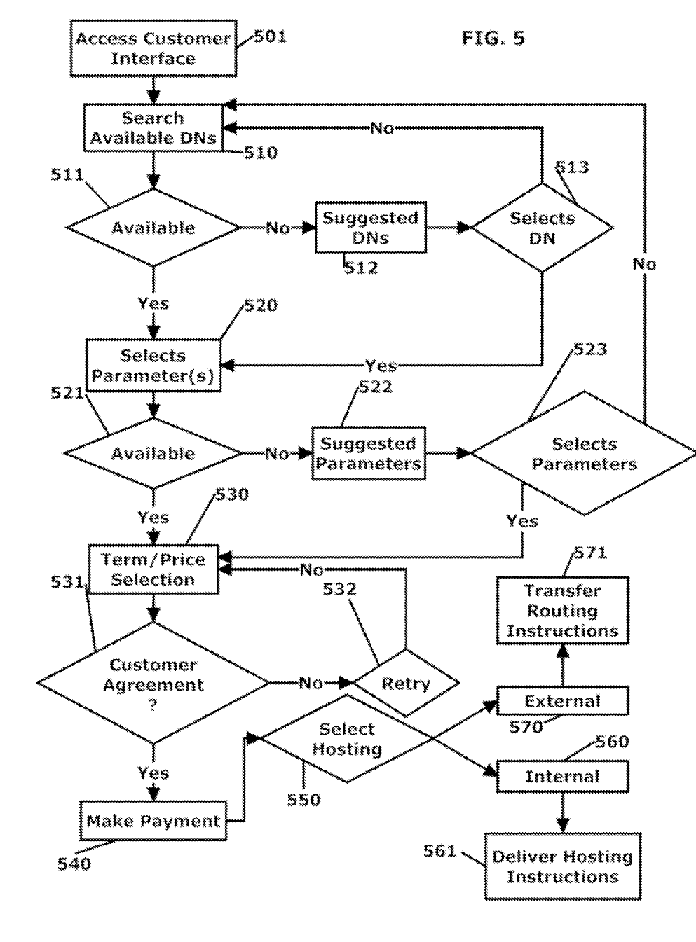

In some embodiments, the leasing system can intake supplied domain names to inventory 130 as discussed in connection with FIG. 3 below. In some embodiments, the internal host server 160 can partition memory in a manner likely to reflect domain customer selections 150 as discussed in connection with FIG. 4 below. For purposes of this invention, a “domain customer” or “domain sublease customer” is any entity or individual that leases or purchases a domain name via the leasing system for purposes of automatically targeting differentiated website content to Internet users that may access that domain customer's content over a network. As discussed in connection with FIGS. 3 and 5 below, domain owner and/or domain sublease customers may choose to host their website on their own host server or any third-party host server of his or her choosing, any of which would be considered an external server 170. In some embodiments, the internal host server 160 can base the partitioning on any criteria and partition the host server space for the domain name into any number of sub-sections to correspond with the number of unique parameters using said criteria, such as, for example, the number of domain customers already using certain parameters for a given domain name, (whether hosted on the internal host server 160 or an external host server 170), or any other data that could reasonably guide the partitioning of the internal host server 160. In some embodiments, this allocation is not static and can be dynamically changed by the internal host server 160 to adjust to usage patterns and ensure the most efficient partitioning structure.

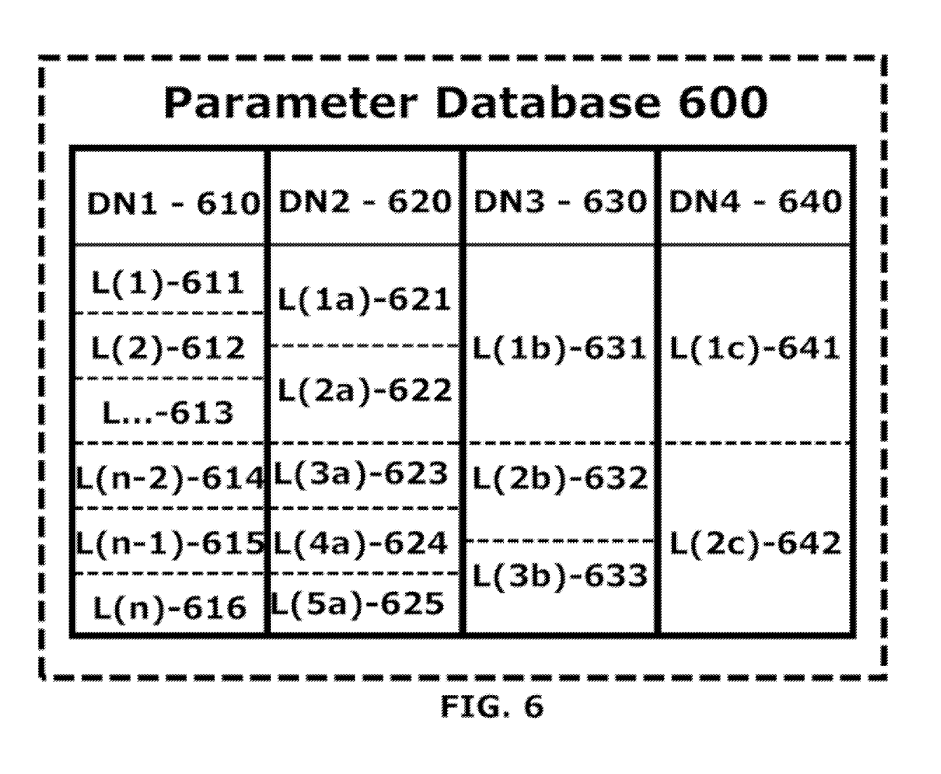

In some embodiments, a domain customer (not shown) can use a client-side interface (not shown in FIG. 1) to access the leasing system and send a request 140 for a domain name or names that contain(s) one or more specific keywords and cover(s) one or more parameters that may or may not mirror the existing partitioning of sub-sectors of any given domain on the internal host server 160. (This process is outlined in FIG. 5 below.) Once a component of the leasing system (such as Allocation Server 180) finds a match between the domain customer's criteria and a domain name in the available inventory 130, the internal host server 160 can receive a domain customer selection 150. Host server space is determined as internal 160 or external 170, and the parameter database (not shown in FIG. 1) within allocation server 180 changes records concerning the location of content for each domain sublease customer parameter (as discussed in connection with FIG. 6 below).

In some embodiments, if the domain sublease customer selects to utilize hosting on the internal host server 160, the domain sublease customer receives instructions via the client-side interface for the transfer of any and all files necessary for the complete delivery of the domain sublease customer's content. Those files (not shown in FIG. 1) are located on the internal host server 160 within the space allocated for the parameter(s) selected by the domain sublease customer during the customer selection process 150.

In some embodiments, if the domain sublease customer selects to utilize hosting on an external host server 170—a server either in the possession of the domain sublease customer or another third party (though still accessible virtually by the domain sublease customer)—the domain sublease customer can provide the Internet Protocol (IP) address or host name of the external host server 170 or other identifying information that provides a reliable means of accessing any and all files necessary for the complete delivery of the domain sublease customer's content hosted on the external host server 170 (which can be recorded in the allocation server 180). In some embodiments, the IP address could be, alternatively, any unique network addressing information sufficient to allow a device or system to exchange information with external host server 170.

In some embodiments, the allocation server 180 can include a plurality of components useful for the delivery of differentiated content to unique users that access a domain name, based on domain customer-defined parameters. Those components can include, but are not limited to, a request intake router, a preference database, an identifying information database, and a parameter database (not shown in FIG. 1). For purposes of the disclosed invention, a “user” or “Internet user” includes any individual or any computerized or other device that accesses domain names or content on the Internet over a network.

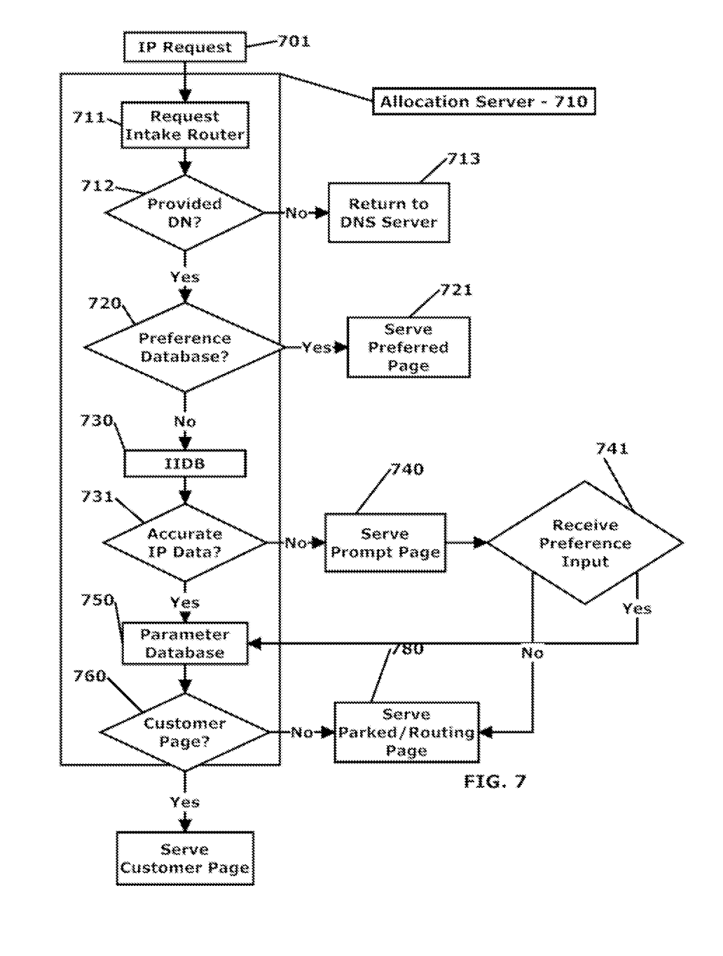

In some embodiments, a user uses a device 181-184 capable of accessing content over a network 190 to input a query (not shown in FIG. 1) for a uniform resource locator (URL). In some embodiments, the network 190 can be, for example, a local area network (LAN), wide area network (WAN), or the Internet. In some embodiments, the user query may originate when an Internet user types a URL directly into a navigation bar of a web browser, when an Internet user clicks a link on a web page that is directed to the requested URL, when the Internet user accesses a Search Engine Results Page (SERP) and selects a link to the requested URL, or other means of using a device to navigate the Internet or input URLs. If the URL corresponds to a domain name provided by the system, the Domain Name System (DNS; not shown in FIG. 1) will direct the request to allocation server 180, along with the IP address of the device 181-184 that originated the query. The DNS may or may not direct the request to a name server 191 that may be, but is not required to be, a part of the domain leasing system. As described in connection with FIG. 7 below, based on differences in domain customer-selected parameters recorded in allocation server 180, the domain leasing system can serve differentiated website content to the requesting device 181-184, via the network 190—be it from internal host server 160 or an external host server 170. In some embodiments, the allocation server 180 can be configured to serve differentiated website content based on the presence of one or more domain sublease records associated with the requested URL and/or domain name and the customer-selected parameters.

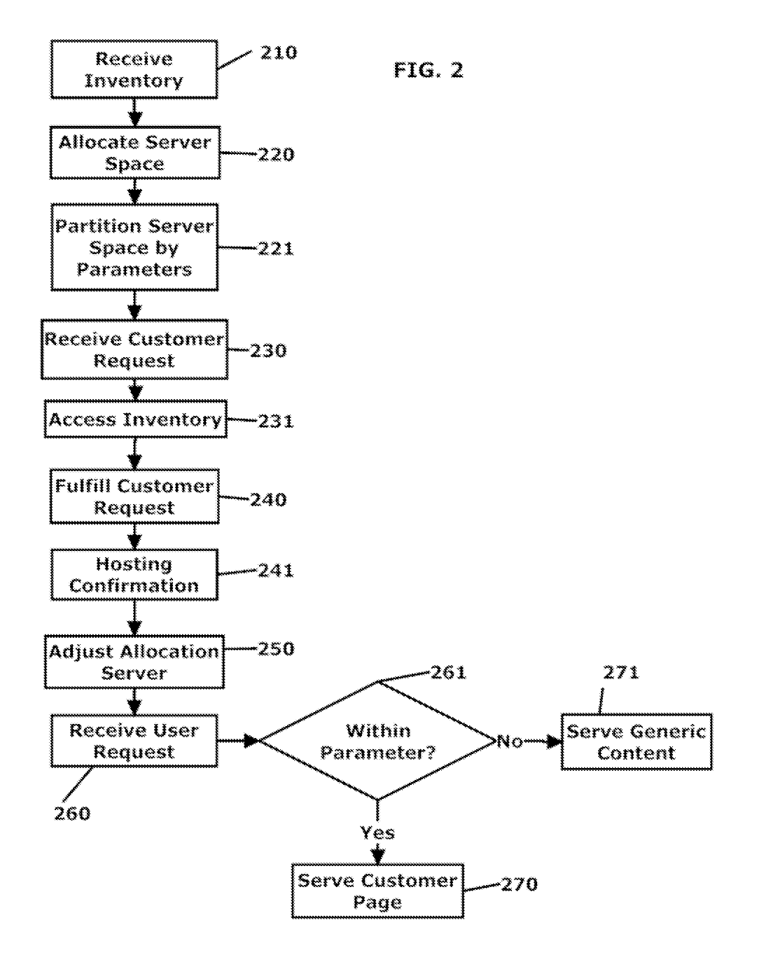

FIG. 2 is a flow chart that outlines steps for the provisioning of a parameter-based domain leasing system. Inventory is brought into the system, either from independent domain owners or internal supply (such as independent domain owners 110 or internal supply 120 as discussed in connection with FIG. 1), 210. For purposes of FIG. 2, the domain name has been independently supplied to the leasing system by a domain owner who has no affiliation to the provider of the leasing system or the operation of the leasing system itself. In such embodiments, the independent domain owner is only required to introduce one or more domain names registered to the independent domain owner into inventory. In such embodiments, the leasing system can execute the provisioning of each supplied domain name to multiple domain customers based on domain customer-selected parameters.

As an example for purposes of FIG. 2, consider the domain name “www.divorceattorney.com”. The domain owner for “www.divorceattorney.com” accesses the leasing system and submits “www.divorceattorney.com” into inventory, 210. (This process is described in greater detail in connection with FIG. 3 below.) The domain “www.divorceattorney.com” is allocated server space and/or memory on the leasing system's internal host servers, 220. At that point, anyone accessing “www.divorceattorney.com” is directed to the internal host server (not shown in FIG. 2) and served or routed to content that includes, but is not limited to, advertisements related to divorce attorney services, the option to lease the domain “www.divorceattorney.com”, content of the independent domain owner's choice, and/or content hosted on one or more external host servers, including external host servers of the independent domain owner's choice. (This content may be collectively referred to as “generic content”.)

In some embodiments, the independent domain owner may also choose to have users falling within certain parameters directed to content of the independent domain owner's choice. For example, one scenario, an independent domain owner could choose to reserve the geographic parameters defined by the state of California. In such a scenario, all users accessing “www.divorceattorney.com” and determined by the allocation server to be accessing “www.divorceattorney.com” from the state of California would be directed to content of the independent domain owner's choosing. All users accessing “www.divorceattorney.com” from a location not within the state of California would be directed to other content, as determined by the allocation server and described above.

Upon receiving a domain name into inventory and allocating internal host server space and/or memory, the internal host server space may be partitioned to reflect possible parameter distinctions, including but not limited to geographic and demographic classifications, 221. For example, in some embodiments, a default setting for parameters can be based on geographic distinctions for Designated Market Areas (“DMA”) in the United States and twenty English-speaking nations outside the United States. Since there are currently approximately 210 DMAs in the United States, combined with 20 English-speaking countries, the internal host server would be divided into 230 separate partitions, each capable of being associated with unique content by a domain customer for delivery to users that access “www.divorceattorney.com” from the corresponding DMA. If the independent domain owner had selected to exclude the state of California, the DMAs and parts of DMAs that comprise the state of California would receive a single allocated space on the internal host server.

The leasing system receives a client-side domain customer request, 230. (This process is described in detail in connection with FIG. 5 below.) In some embodiments, the domain customer can then select a domain name, in this case “www.divorceattorney.com”, which is available in the inventory. The system can access the inventory to determine domain name availability, 231. In some embodiments, the domain customer can then select parameters that may or may not reflect the partitioning of the internal host server. The domain customer may request to lease or purchase a parameter that includes, for example, the Miami, Fla. DMA and the country of Jamaica. If each of those geographic areas does not already fall within parameters selected by any other domain customer for the “www.divorceattorney.com” domain, the leasing system can grant the domain customer's request. If the domain customer chooses to utilize the internal host server, an allocation server (not shown in FIG. 2) can allocate space and/or memory on the internal host server so that the domain customer's content will reside in a single place on the server and be accessed by users from within the Miami, Fla. DMA and the country of Jamaica. Whether the content is located on an external or internal host server may be determined by the provider of the domain sub-leasing system. The domain customer may also elect to host its content on an external host server, in which case the allocation server can eliminate the space and/or memory on the internal host server allocated to the Miami, Fla. DMA and the country of Jamaica, to make it available for other partitions.

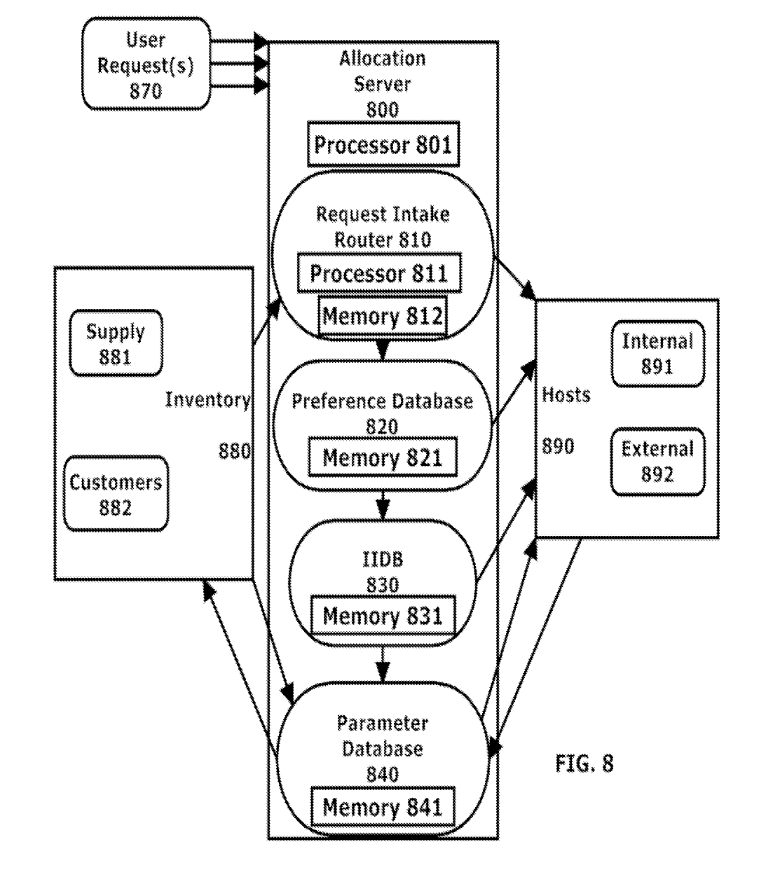

The leasing system receives and fulfills a client-side user request, 240. The system confirms hosting information for the internal or external hosting request, 241. In some embodiments, the leasing system can make adjustments to the allocation server, 250. (This adjustment process is illustrated in detail and discussed in connection with FIG. 8 below.) In some embodiments, these adjustments apply to the parameter database, which maintains records governing which parameters correspond to IP addresses or other routing methods identifying the location of content on either an internal or external host server. For example, a domain customer that selects “www.divorceattorney.com” and whose parameters include Miami, Fla. and Jamaica can choose to host his or her content on internal host servers. In such a scenario, the parameter database can record the IP address, folder or other location information for that content, and direct user devices accessing the Internet from Miami, Fla. or Jamaica seeking www.divorceattorney.com to the appropriate folder or other content location.

An Internet user sends a webpage request that includes a URL, 260. In some embodiments, if the URL is directed to a domain name provided within the leasing system, the request first travels from the user's computer or device across a network (typically the Internet) to a Domain Name System (DNS) server for redirection to the appropriate location.

In this example, the requesting computer or device sends the URL “www.divorceattorney.com”, which is provided by the leasing system. Per the routing protocols and standards of the Internet, the request is first received by the DNS server assigned to the requesting computer or device, from which it is forwarded on to whichever server is assigned the IP address associated with “www.divorceattorney.com”. The name server for “www.divorceattorney.com” (which may or may not be a name server internal to or controlled by the leasing system or allocation server) receives the request and directs it to the leasing system allocation server, including in the request the IP address of the requesting device and any other identifying information of the Internet user making the request.

The allocation server determines whether the received Internet user characteristics match the parameters specified by any domain customer for the requested domain name, 261. In this example, the requesting device is located in Miami, Fla., which matches a parameter defined by a domain customer for the requested “www.divorceattorney.com” domain. This being the case, the allocation server routes the requesting device, via the parameter database, to the host server for the content provided by whichever customer has subleased the requested domain with a selected parameter that covers the Miami, Fla. DMA.

If the allocation server determines, based on the identifying information, that the requesting device is physically present in a location that has not been selected as a parameter by any domain customer for the “www.divorceattorney.com” domain, the allocation server can direct the Internet user request to the internal host server and serve generic content, 271. Generic content for parameters not selected by domain customers may also reside on an external host server.

FIG. 3 is a flow chart outlining an exemplary process for the intake of one or more domain names from an independent domain owner into a parameter-based domain leasing system inventory.

A domain name registrant (owner), an agent for a domain owner or someone authorized to act on behalf of a domain owner, 301, uses a device to access a client-side listing interface 310 via the Internet or other means of communication across a network (such as a LAN, WAN, or Intranet). In some embodiments, the domain name registrant 301 may attempt to enter one or more domain names into the system inventory through the listing interface 310. In some embodiments, the listing interface 310 is not the sole means by which a domain name registrant may enter domain names into the system inventory. Rather, in some embodiments, the domain name registrant 301 may also complete all or parts of the process outlined in FIG. 3 by phone, mail, or electronic communication with someone capable of accessing the listing interface 310.

Upon accessing the listing interface 310, which may be a public or privately accessible interface on a network, the domain name registrant 301 may input, upload or supply to the listing interface 310 by other means the one or more domain names that the domain owner seeks to add to the system inventory. The listing interface 310 receives the domain owner's request and compares the request with an authorization database to determine whether one or more domain names submitted are not allowed by the system, 311. The authorization database (not shown in FIG. 3) may include all domains comprised of trademarked words, words of an explicit nature, or any other category of words or domain names defined in the authorization database, such as domain names currently under dispute at the World Intellectual Property Organization (WIPO). The authorization database may also comprise a list of approved domain names. In some embodiments, the approved domains and submitted domain names may also be subjectively reviewed by an evaluator that determines the likely value of the domain name in the domain sub-leasing system and authorizes its entry into inventory or not based on that evaluation.

Upon one or more of the submitted domains being approved via the authorization database or other means and criteria, the domain name registrant 301 may select the length of agreement, 312. In some embodiments, the domain name registrant 301 can specify the amount of time for which the system is authorized to list the submitted domain name for selection of parameters by domain customers. This selection may apply equally to each submitted domain name or be unique to one or more of the submitted domain names. The selection may specify any period of time, including, e.g., 24 hours, 6 months, 5 years, or any other period of time (including in perpetuity).

Upon receiving a selection specifying an agreement length, in some embodiments the listing interface can require that the domain name registrant digitally, via fax, via phone, or via other means of communication authorize a listing agreement, 313. If the domain name registrant 301 chooses not to authorize the listing agreement, in some embodiments the listing interface can suggest again, for one or more iterations, that the domain name registrant 301 agree, 314. If the domain name registrant 301 continues to not agree with the listing agreement, the system can direct the domain name registrant 301 back to the original listing interface 310. If the domain name registrant 301 agrees to the terms of the listing agreement, the listing interface can direct the domain name registrant 301 to confirm the domain name registrant's ownership of the submitted domain or domains, 320. This means of ownership confirmation may include, but is not limited to, adding by the domain name registrant of unique CNAME records randomly generated by a processor capable of generating such random records as part of the listing interface. The listing interface can confirm these changes to CNAME records by accessing the new CNAME records as publicly available and confirming their existence. Other common methods may also be used to certify the ownership of the domain by the domain name registrant submitting the domain, including verifying that the name servers or other records for the domain name(s) have been changed per the instructions of the domain sub-leasing system.

The system can then direct the domain name registrant 301 to point the addressing information of the domain name (such as an IP address, one or more CAME records, or other means of directing a domain name) for each submitted domain to a provided name server, IP address, host name or other defined location that corresponds to the allocation server, 330. Upon successful pointing of the domain name by the domain owner to the assigned IP address, host name, or other defined location, an automated client within the listing interface can access the assigned IP address, host name, or other defined location and receive or not receive confirmation from the allocation server that the domain name is successfully pointed to the allocation server, 331.

If the domain pointing is successful, the listing interface can set up a means of payment from the domain customer to the domain owner for a portion of revenues generated from the supplied domain name, 340. The means of payment can be, for example, electronic funds transfer (EFT), PayPal account, check by mail, or any other suitable means of providing payment to the domain owner. If the domain owner chooses a method of automatic electronic payment, 341, successful setup of the automatic payment must be confirmed for those methods where such confirmation is possible. If the confirmation is successful, the leasing system can add the domain name(s) to the system inventory, 350. At this point, the domains are available, and domain customers can select parameters that correspond with the domain name(s). If a domain customer's automatic payment setup cannot be confirmed, the system can direct the customer back to the original payment setup. In some embodiments, the system can add to inventory supplied domain(s) of customers who do not choose automatic payment, allowing for payment via other means.

FIG. 4 is a schematic block diagram that illustrates a partitioning of an internal host server associated with a domain leasing system based on likely parameters. More specifically, FIG. 4 illustrates an internal host server 420 that receives a newly supplied domain name 410. In some embodiments, the internal host server 420 can define one or more memory partitions, thereby defining a partitioned domain name 430. In some embodiments, the internal host server 420 can partition memory to reflect possible parameter distinctions, such as those described in connection with FIG. 2 above, including but not limited to geographic and demographic classifications. In some embodiments, a supplied domain name 410 may or may not be entirely hosted on the internal host server 420, depending on whether the domain owner (not shown in FIG. 4) has reserved certain parameters and chosen to host content for those parameters on an external host server, such as external host servers 440 and 441.

In some embodiments, an allocation server (such as the allocation server discussed in connection with FIG. 8 below) may direct partitioning of the supplied domain name 410 to reflect likely domain sublease customer parameter selections, based on, for example, the history of domain sublease customer parameter selections for domains containing similar keywords, domains supplied for a similar length of time according to the domain owner, or any other criteria reasonably likely to indicate future parameter selections by domain customers. As shown in FIG. 4, storage memory for content associated with partitioned domain name 430 can be divided into multiple partitions, such as partitions 431-439. In the illustrated example, partition 431 should be considered P(1), partition 432 P(2), partition 437 P(n−2), partition 438 P(n−1), and partition 439 P(n) where “n” indicates the total number of partitions hosted on the internal host server 420 and not including those hosted on external host servers 440 and 441. In some embodiments, the size and bandwidth initially assigned to each partition can be minimal, but may reflect differing characteristics of each partition. For example, if P(1) to P(n) reflects the aforementioned 210 DMAs in the United States, ordered from largest to smallest, with P(1) being the most populated DMA and P(n) being the least populated DMA, then P(1) would be allocated the most server space and bandwidth and P(n) the least. In such a scenario, each partition in between P(1) and P(n) would be allocated progressively less space and bandwidth as P(x) approaches P(n). In some embodiments, each external host server 440-441 may include a unique set of content to be served based on different parameters, which are recorded in the allocation server (not shown in FIG. 4). Content that is located on an external host server 440-441 may also have a partition on internal host server 420 that contains cached versions of the externally hosted content or other content that facilitates the most efficient delivery of content in response to client-side requests.

FIG. 5 is a flowchart that outlines steps for the creation of a parameter-based lease in a domain leasing system. In FIG. 5, a domain sublease customer (not shown in FIG. 5) accesses a client-side domain customer interface, 501. In some embodiments, the domain sublease customer can access the client-side domain customer interface via the Internet or other means of communication across a network. In some embodiments, the domain customer interface 501 can be not the sole means by which a domain sublease customer may select parameters and execute a lease from the system for a supplied domain name. In such embodiments, the domain sublease customer may also complete all or parts of the process outlined in FIG. 5 by, for example, phone, mail, or via other correspondence with an individual capable of accessing the domain customer interface 501.

Upon accessing the domain customer interface 501, which may be a public or privately accessible interface on a network, the domain sublease customer can execute a search for available domain name(s), 510. In some embodiments, the search may include a variety of query terms corresponding to criteria that are recorded in the inventory database and may include, but are not limited to, domain names, geographic criteria, demographic criteria or any other possible criterion or criteria. Upon receiving the search query terms, the system can accesses the inventory database and determine whether one or more domain names matching the query terms of the search query terms are available for lease, 511.

If no domain names matching the search query terms are available, the system can access the inventory database to find additional domain names based on keyword, similar criteria (such as a geographic location physically adjacent to a searched-for geographic location), or any other reasonable criteria that could indicate a match between the query terms and a domain name and parameter combination that is available in the inventory database. In some embodiments, the domain leasing system can suggest any similar domain name(s) to the domain sublease customer, 512. In such embodiments, the domain sublease customer may choose a suggested domain name, 513, and be directed by the system to select specific parameter(s), 520. In some embodiments, the customer can instead choose to reject the selected domain names, whereupon the system can direct the domain customer to a new search, 510.

If the domain sublease customer's original search yields available domain name(s) from the inventory database, or the domain sublease customer selects from the subsequently-suggested domain names returned after no original results were available, the system can direct the domain sublease customer to select parameters 520. At step 510 the domain sublease customer may have indicated an interest in specific parameters or in one or more domain names in general, irrespective of any parameters.

The domain sublease customer may select parameters, 520. In some embodiments, the selected parameters can include but are not limited to: any geographic factor, demographic factor, or any other reasonably determined and partitioned factor. Geographic factors can include, but are not limited to: continent, nation, state, region, DMA, city, zip code, neighborhood, building, address, transportation network, latitude/longitude coordinates, or any other means of determining a geographic area. Demographic factors can include, but are not limited to: age, income, family status, education level, language, nationality, race, religion, or any other means of identifying a demographic subset of the global population. In some embodiments, the domain sublease customer may select any parameters or combination of parameters as long as the selected parameter(s) do not overlap with any parameters already selected by another domain customer for that domain name stored in the system.

For example, domain sublease customer A may have selected the state of Florida as their parameter. Customer B, attempting to select the southeastern United States would be unable to do so because Florida matches that parameter and has already been selected by domain sublease customer A. Customer B could choose instead a parameter that includes all the southeastern United States except Florida. For this reason, domain sublease customers may tend to select parameters that correspond to traditional geographic demarcations for marketing, such as DMAs, or to traditional demographic factors, such as income level. If one domain customer C were to choose the Atlanta, Ga. DMA, they would have the exclusive right to determine content for the selected domain for all users accessing the selected domain from the Atlanta, Ga. area. If another domain sublease customer D attempts to select a demographic parameter, such as any zip code with an average family income greater than $80,000/year, and any of the zip codes falling within that parameter are within the Atlanta, Ga. DMA, then domain customer D would either a) not be allowed to select that demographic parameter or b) be required to agree that any users within the Atlanta, Ga. DMA that also are in zip codes with average household income of greater than $80,00 would be excluded from accessing domain customer D's content.

In some embodiments, the inventory database can exchange data with the allocation server on a real-time basis to determine the availability of domain names and parameters, thereby ensuring no overlapping of domain sublease customer parameters.

In an alternate embodiment of the invention, domain sublease customer parameters may overlap, and users can be directed to each domain customer on a proportional basis.

If the domain sublease customer does not make a selection from the available parameters offered, 521, the system can access the inventory database and determine whether there are any similar or adjacent parameters that may be of interest to the domain sublease customer based on the specifications the domain sublease customer has indicated to that point. In such embodiments, the system can then display the suggested alternative parameters to the domain sublease customer, 522. Once the domain sublease customer determines available parameters or selects from the suggested alternative parameters that are non-overlapping with any previous domain customer's parameters for the same domain name, 523, the domain customer interface can direct the domain sublease customer to select from a list of terms and prices, 530. If the domain is supplied by an independent domain owner, the term selected by the domain sublease customer must fall within the term set by the domain owner.

For example, if a domain owner has agreed, as discussed in connection with FIG. 3 above, to supply a domain name for a given term, such as two years, and the time remaining until the expiration of that two years is one year, then the domain customer may select a term no greater than one year. The price may vary based on the term of the lease, the given parameters, the domain name itself, or any other factor that could be determined to affect the value of the domain name. The price may be determined using a fixed structure, using a dynamic pricing algorithm based on historical and predicted information, an auction structure, a reverse auction structure, seasonal pricing, special pricing, or any other means reasonably used to arrive at a price for a product or lease in the marketplace.

In some embodiments, the term of the lease may also be indefinite, assuming the agreement with the domain owner is to provide the domain through the domain leasing system in perpetuity. In the case of an indefinite lease, the nature of the transaction may be equivalent to a sale, and the pricing may be structured and determined accordingly. If the domain sublease customer does not select any parameters or suggested parameters, then the system can direct the domain sublease customer back to the original search, client-side domain customer interface, 510.

Once the domain sublease customer has selected a term and price, the system can direct the domain sublease customer to digitally authorize the domain customer agreement, 531. In some embodiments, if the domain sublease customer chooses not to sign the agreement, the domain customer interface can suggest again, for one or more iterations, that the domain sublease customer indicate agreement, 532. If the domain sublease customer continues not to agree with the listing agreement, the system can direct the domain sublease customer back to the term/price selection screen 530. If the domain sublease customer agrees to the terms of the domain customer agreement, the domain sublease customer interface can direct the domain sublease customer to a means of making payment for the selected domain and parameters, 540. The process of agreeing to the terms may occur before or after the payment information is determined and may be done via any means of communication.

The payment may be for a portion of the agreed term, for the entire agreed term, or for none of the agreed term, as the payment may be made in advance of the initiation of service via the allocation server, after some period of service has been provided or after the entire term of the service. Payment may be made via electronic funds transfer (EFT), PayPal account, check by mail or any other suitable means of providing payment to the provider of the system.

Once the system has received and confirmed payment, the domain sublease customer can select whether their own content for the domain and parameter(s) selected should be hosted either on internal host server or an external host server, 550. If the domain sublease customer selects internal host server 560, then the client-side domain customer interface can access the allocation server and determines a partition allocated for the hosting of the selected domain name and parameter(s). The domain customer interface can then deliver appropriate instructions to the domain sublease customer for uploading the necessary files to be hosted to the appropriate partition of the internal host server 561.

If the domain sublease customer selects external host server 570, which may either be a host server belonging to the domain sublease customer or a third-party host server accessible by the domain sublease customer, then the domain customer interface can require the domain sublease customer to supply routing instructions, including the IP address or other identifying information 571 for directing to the external host server on a network. In some embodiments, the system can store this information at the allocation server.

FIG. 6 is a schematic block diagram that illustrates a parameter database organizing the location of content on host servers based on customer-selected parameters in a parameter-based domain leasing system. More specifically, FIG. 6 illustrates a real-time parameter database 600 that maps provided domain names 610, 620, 630, and 640 to the location of unique domain name content for different domain customer-selected parameters 611-616, 621-625, 631-633, and 641-642 on internal and external host servers.

For example, in some embodiments DN1 610 could be text information including the domain name “www.divorceattorney.com”, partitioned into (n) partitions within the parameter database 600. In FIG. 6, L(2) 612 is the selected parameter of domain customer E (not shown in FIG. 6) who has selected the Chicago, Ill. DMA. In some embodiments, the parameter database can be one component in the memory of and receives its queries from an allocation server (not shown in FIG. 6), such as the allocation server discussed in connection with FIG. 8 below. In some embodiments, the parameter database can receive one or more queries from the allocation server, each containing a request for a domain name (such as www.divorceattorney.com), and information relating to the source of that domain name, such as its geographic location. In such embodiments, the parameter database 600 can receive the requested domain name 610 and then map whichever parameter in the range L(1) 611 and L(n) 616 encompasses the geographic source of that domain name.

In the above example, Internet user Z (not shown in FIG. 6) has accessed domain “www.divorceattorney.com” from Chicago, Ill., with this location having been identified by the allocation server. In such an example, parameter database 600 can determine that Chicago, Ill. is physically located within L(2) 612 for DN1 610. In some embodiments, the parameter database can contain the routing information necessary to direct a requesting device used by an Internet user, such as Internet user Z, to the content provided by a domain customer associated with a physical location of the requesting device, such as the domain customer of L(2) 612. This routing information may include, but is not limited to, an IP address, a web server subfolder, unique domain name, or any other means of accessing content on the Internet.

FIG. 7 is a flowchart that outlines a process by which an Internet user accesses content associated with a domain name within a parameter-based domain leasing system. In FIG. 7, an Internet user Y (not shown in FIG. 7) initiates an Internet Protocol (IP) request 701 for a domain name (such as www.divorceattorney.com) that is supplied by the parameter-based domain leasing system. Via standard Internet routing processes, such as that outlined in FIG. 3 above, the supplied domain name points via IP address to the request intake router 711, and directs a user request via the Domain Name System (DNS) to the request intake router 711. In some embodiments, the DNS could alternatively be any software- or hardware-based module that serves to direct network traffic to the appropriate resource or device. The request intake router accesses its tables, which are updated by the inventory database (not shown in FIG. 7), to confirm that the requested domain name is provided by the system, 712. If the requested domain name is not provided by the system, the request intake router returns the user request to the DNS, 713. In some embodiments, the request intake router may be integrated with one or more name servers that are accessed directly via the DNS.

If the requested domain name is provided by the system, then the request intake router 711 can record the IP address and any other available identifying information (such as an Internet cookie of the Internet user Y making the request for the domain www.divorceattorney.com) and deliver it to a preference database, 720. In some embodiments, the preference database can be part of an allocation server 710.

In some embodiments, preference database 720 contains information regarding previous requests from Internet users for domain names supplied by the system. During these previous requests, an Internet user whose device has a certain IP address, cookie, or other identifier for a device on a network may have made a specific request to be served content from a parameter different from that which they are automatically directed to by allocation server 710. In this case, that preference is stored in preference database 720, and the allocation server immediately accesses the routing information necessary to direct the Internet user making request 701 to the preferred content, 721. This routing information may include, but is not limited to, an IP address, a web server subfolder, unique domain name, or any other means of accessing content on the Internet.

If identifying information of the Internet user making request 701 is not contained in preference database 720, then the allocation server can access an identifying information database 730. In some embodiments, identifying information database 730 can contain information that maps IP addresses and/or other Internet user identifying information to other information about an Internet user with that identifying information, such as the user's physical location, demographic information, or any other determinable information set. In the described example, the identifying information database contains information regarding the universe of existing IP addresses and the likely physical location from which that IP address originates, along with an associated measure of confidence or accuracy. For example, identifying information database 730 contains information indicating that the IP address of that Internet user's device originates from the Boston, Mass. DMA and a field indicating a 99% degree of accuracy for that mapping 731. The allocation server may or may not incorporate accuracy as a factor.

In some embodiments, the allocation server 710 receives this information and initiates a request to a parameter database 750 based on this received information. For example, if identifying information database 730 states with only 30% accuracy 731 that Internet user W originates from the Cleveland, Ohio DMA, then the allocation server processes that information and determines that Internet user W should be served with a prompt page 740 requesting that she identify her location so that content within the appropriate parameter may be determined by accessing parameter database 750. If Internet user W does not respond to the prompt with a preference, then she is served generic content 780. If Internet user W does respond with a preference 741, the amended user request is directed to parameter database 750, and the Internet user preference is recorded by the allocation server in preference database 720.

As discussed in connection with FIG. 6 above, allocation server 710 can access parameter database 750 above using information that includes the domain included in the user request 701 and identifying information that may or may not correspond to domain customer-selected parameters residing in parameter database 750. Parameter database 750 returns information indicating whether user request 701 falls within the parameters of a domain customer for the requested domain. If the request does fall within domain customer-selected parameters, then the parameter database returns the routing information necessary to direct the Internet user making request 701 to domain customer content 770. This routing information may include, but is not limited to, an IP address, a web server subfolder, unique domain name, or any other means of accessing content on the Internet. If the request does not match domain customer-selected parameters, then the parameter database returns the routing information necessary for serving generic content 780.

FIG. 8 is a schematic block diagram that illustrates components of an allocation server portion of a parameter-based domain leasing system. More specifically, FIG. 8 illustrates an allocation server 800 responsible for the effective routing of Internet users to the appropriate content within a domain customer-defined parameter so that multiple domain customers are able to use a single domain name. In some embodiments, the allocation server 800 can deliver differentiated content to unique requests for a single domain name. As illustrated in FIG. 8, allocation server 800 can receive a plurality of inputs from inventory 880 that originally derive from domain owner suppliers 881 (as discussed in connection with FIG. 3) and domain customers 882 (as discussed in connection with FIG. 5). Allocation server 800 processes these inputs 880 in conjunction with Internet user requests 870 to deliver differentiated content to client-side Internet users via host servers 890, both internal, 891, and external, 892.

As shown in FIG. 8, allocation server 800 can include a processor 801, a request intake router 810, a preference database 820, an identifying information database (IIDB) 830, and a parameter database 840. Request intake router 810 can include a processor 811 capable of receiving user requests 870 directed at IP addresses recorded in a table of request intake router 810, housed in a memory 812. The memory 812 includes IP addresses for each domain housed in inventory 880 and is capable of capturing identifying information of the requesting user, such as the IP address of the Internet user's requesting device or other identifying information.

The table in memory 812 of request intake router 810 can include information identifying the hosted location of all subfolders and sub-domains of domain names in inventory. If request intake router 810 receives a user request 870 that includes a sub-domain or subfolder of an IP address in the inventory table, the request intake router processor 811 directs allocation server 800 to deliver to the requesting user the requested content from the appropriate host location.

If user request 870 does not specify a subfolder or sub-domain, request intake router 810 pairs the request with its captured identifying information, and allocation server processor 801 uses the captured information to access preference database 820. Preference database 820 records in memory 821 information that cross-references whether the identifying information accompanying the request is associated with any information regarding a previous request for the domain in question or any other domain. If the Internet user has previously made a request for the same domain name, as identified by the IP address of her requesting device, a user cookie, or other identifying information, and has indicated a preference to be classified within certain parameters according to preference database 820, then the sub-domain, subfolder, unique domain name, or other method of identifying the preferred content as recorded in preference database 820 can be accessed by allocation server processor 801, and the allocation server 800 can deliver to the requesting user the requested content at the appropriate host location.

If preference database 820 does not contain a record corresponding to identifying information of user request 870, then the query by allocation server 800 of preference database 820 can return a null result. In some embodiments, allocation server 800 can then access IIDB 830 using the identifying information collected from request intake router 810. IIDB 830 records in memory 831 information from any number of data points from one or more sources capable of mapping, with some recorded degree of certainty, user identifying information (such as an IP address) to a geographic, demographic or other characteristic of the requesting computer or device.

In some embodiments, IIDB 830 can include a GeoIP database. A GeoIP database may contain information that describes the geographic location of a requesting computer or device at the national, regional, local, DMA or other level, based on the computer or device's IP address. In some embodiments, IIDB 830 can include a database of U.S. census data that includes average household income by zip code. In some embodiments, IIDB can map the connection between the IP address of an Internet user's device and the likely range of that user's household income, by using a zip code field to connect information in the GeoIP and U.S. Census databases.

In some embodiments, the IIDB 830 can combine as few or as many component information sets as needed to determine geographic, demographic or other characteristics of a requesting user that correspond to domain customer-selected parameters. Geographic factors that may be recorded in the information sets that are stored in IIDB 830 include, but are not limited to, continent, nation, state, region, DMA, city, zip code, neighborhood, building, address, transportation network, latitude/longitude coordinates, or any other means of determining a geographic area. Demographic factors that may be recorded in the information sets that are stored in IIDB 830 include, but are not limited to, age, income, family status, education level, language, nationality, race, religion, or any other means of identifying a demographic subset of the global population. For some domain customer-selected parameters, there may be no effective means of automatically determining the relevant user characteristic. In those instances, the Internet user must be prompted to enter the relevant information, (as described in connection with FIG. 7 above), which would be recorded in preference database 820.

Allocation server processor 801 accesses IIDB 830 to determine what information, if any, is available to connect the Internet user making a request with characteristics of that Internet user. Parameter database 840 records input from inventory 880 in memory 841, including domain owner information 881 (which determines all domains available in the system) and domain customer information 882 (which determines which parameters for any given domain are registered to a specific domain customer). All parameters that are not assigned to a specific domain customer are available to be served generic content. Parameter database 840 also receives information from the aforementioned sources and records the exact location of the hosted content, as determined by IP address, web server subfolder, Internet sub-domain, unique domain name or other host-identifying information, for each corresponding domain customer-defined parameter and each parameter that has not yet been selected by a domain customer.

In some embodiments, allocation server 800 combines the received information from IIDB 830 with information from request intake router 810 concerning which original domain was requested by user 870 and accesses parameter database 840 using those multiple data points.

Upon receiving a request via allocation server processor 801, parameter database 840 matches the requested domain name and one or more user characteristics to determine if those user characteristics match any parameters for the requested domain name. If so, the parameter database 840 returns the location of the appropriate host server 890 for the requested content. Allocation server 800 delivers to the requesting user the requested content from the appropriate host location.

Parameter database 840 may include a probability-based calculation that combines the information regarding the requested domain name and one or more user characteristics with one or more of the following components to determine the appropriate host server 890 for the requested content: the requesting user's history, the requesting user's recorded preferences, the historical preferences of other requesting users, the usage patterns of other requesting users that have initiated one or more actions similar to that of the instant requesting user, general Internet trends regarding the popularity or relevance of certain content, or any other factor that may be reasonably related to determining the appropriate requested content. Based on these additional calculations, parameter database 840 can identify the location of the appropriate host server 890 for the requested content, and allocation server 800 delivers to the requesting user the requested content from the appropriate host location.

In some embodiments, allocation server 800 may direct to parameter database 840 a request for which the Internet user's identifying information is not recorded in preference database 820. In such an instance, parameter database 840 can receive from allocation server 800 the domain name requested and return which domain customer-defined parameter(s) have been used for that domain name. In some embodiments, allocation server 800 could then make a request from IIDB 830 where, instead of retrieving all user identifying information (as it would when accessing IIDB 830 following preference database 820), it would only retrieve the relevant user characteristic as had been determined from parameter database 840. Allocation server 800 could then return the request, along with the relevant user characteristic, to parameter database 840, allowing allocation server 800 to retrieve the location of the appropriate host server 890 for the requested content.

The components of allocation server 800, including but not limited to processor 801, request intake router 810, preference database 820, IIDB 830, and parameter database 840, may be located in one or more devices connected via a network (such as a local area network (LAN), wide area network (WAN), Intranet, or the Internet), on a single physical server, may be spread across multiple physical servers, may be co-located on a virtualized server, or spread in one or more pieces across multiple virtualized servers. These components may also each be duplicated one or more times within the description of allocation server 800 to ensure allocation server 800 does not have any choke points or load restraints that inhibit performance. The entire allocation server 800 may also be duplicated one or more times, in whole or in part, across multiple physical or virtualized servers to achieve optimal performance of a global parameter-based domain leasing system. Alternatively, the allocation server 800 could be a software-based module that resides on one or more processor-based devices, such as a personal computer or server.

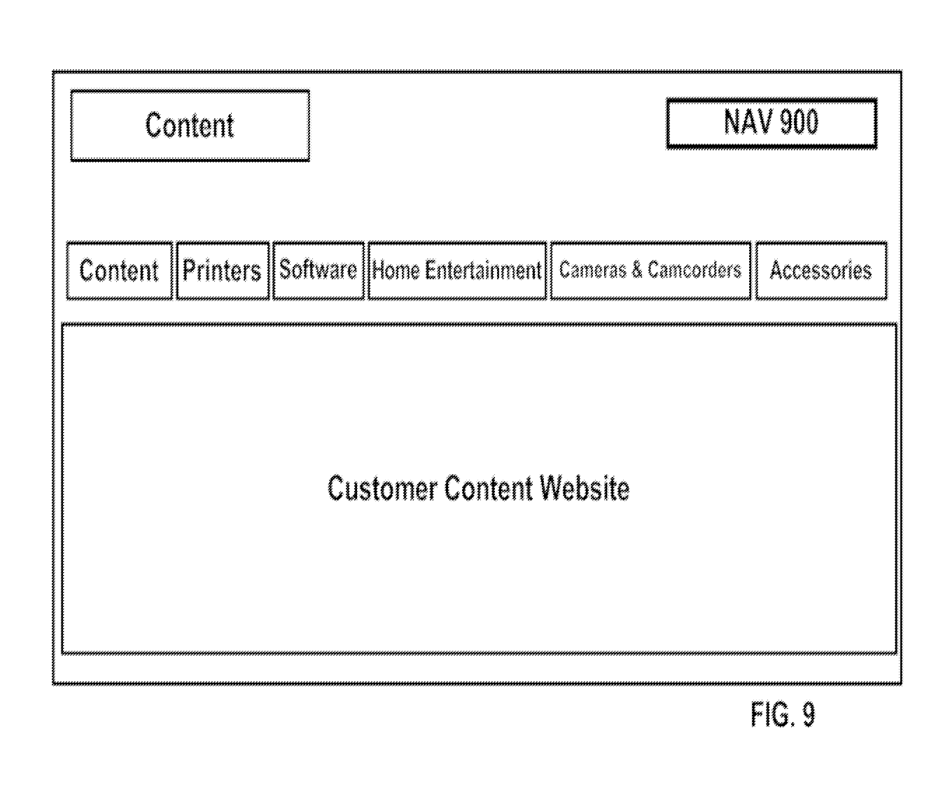

FIG. 9 is a graphical illustration that illustrates a graphical interface that allows an Internet user to access content of a domain customer other than that to which the Internet user has been automatically directed by an allocation server (not shown in FIG. 9) associated with a parameter-based domain leasing system. In some embodiments, the allocation server, based on the Internet user characteristic(s) determined by the IIDB (not shown in FIG. 9), may direct an Internet user to content that either a) is not responsive to characteristics of that Internet user and/or b) is not the preferred content of that Internet user, regardless of the Internet user's characteristics.

In one example, Internet user U accesses the website “www.divorceattorney.com” from within the Chicago, Ill. DMA and is automatically directed by the allocation server to content for the domain customer of the domain “www.divorceattorney.com” whose selected parameters include the Chicago, Ill. DMA. However, in the contemplated example scenario, Internet user U is looking for the content of the domain sublease customer of the domain “www.divorceattorney.com” whose selected parameters include Denver, Colo. In this or any similar instance, the Internet user can access navigation element 900, which can be configured to direct the Internet user to a prompt requesting user input. In some embodiments, the prompt can request user input of a preference for the parameter (e.g., geographic location) within which they prefer to be considered by the domain subleasing system. Upon receiving this user input, the allocation server will determine which content to deliver to Internet user U based on the amended request—just as it does when accessing the preference database. At this point, the allocation server can direct Internet user U to the hosting location of the preferred content.

In some embodiments, navigation element 900 can be placed on each domain customer web page. In some embodiments, the particular placement of navigation element 900 may be based at least in part on, for example, a domain customer placement selection, the insertion of a macro frame element, the use of an “include” function, the display of a popup window, or any other known method for placing such an element across an array of content pages. Due to the above-described functionality, each Internet user will, therefore, always be capable of navigating from the content of any one domain sublease customer to the content of any other domain sublease customer for that domain.

In another embodiment of the invention, an allocation server can allow a single domain customer to provide differentiated content based on different geographic or demographic parameters, and/or to define user access based on whether the request originates from a private or public network. For example, ABC Law Firm may own the domain name “www.abclawfirm.com” and have physical or virtual offices in 20 cities around the world. Certain subfolders or sub-domains of “www.abclawfirm.com” may have restricted, private access for members and employees of the law firm on a private network. In one embodiment, the allocation server could be employed to directly and programmatically route the public Internet and private network requests to “www.abclawfirm.com” or specific subfolders or sub-domains of “www.abclawfirm.com” to the appropriate local or targeted content based on the origin of the request.

In the various uses of this device and system, the system can include a device for the operation of a single domain name by multiple content providers via an allocation server. The allocation server is an example of such a device and is capable of differentiating delivered content to requests for a single domain name. The allocation server may include a processor for the retrieval of information from a request intake router, a preference database, an identifying information database, and a parameter database and the delivery of differentiated content to the requesting client. The allocation server may also include a request intake router for the receipt of DNS requests (which may itself be a name server), a preference database for the recording of user preferences, an identifying information database for the recording of user-identifying information with geographic, demographic or other characteristics, and a parameter database for the recording of content location and the parameters for which it is to be served.

The allocation server or similar device may be hosted on a dedicated server, hosted on a network, such as a LAN, a WAN, and Intranet, or the Internet, co-located across multiple dedicated servers or replicated multiple times for load balancing purposes. One or more components of the allocation server may be replicated multiple times for load balancing purposes. The allocation server processor may be one or more unique processors acting in conjunction. The memory for the preference database, the identifying information database, or the parameter database may not be physically located within the memory of each respective component but accessed from a remote provider or remote memory bank.

The user-identifying information in the identifying information database may be geographic at the international, national, regional, designated market area (DMA), city, neighborhood, or address level or any other level reasonably suited to defining one or more contiguous or non-contiguous geographic areas. The user-identifying information in the identifying information database may also be demographic based on an age grouping, an income grouping, a socio-economic grouping or any other means of grouping one or more Internet users that may be determined automatically or via prompt.

This domain leasing system is capable of providing a single domain name to multiple domain customers on an exclusive basis using a domain customer-defined parameter. That parameter may describe an Internet user characteristic and be structured as such that any Internet user falling within the scope of that parameter will be automatically directed to the domain customer's preferred Internet destination when accessing the provided domain name.

The domain leasing system may be operated so that any Internet user that accesses the supplied domain name will be directed to the domain customer's specific website if the Internet user falls within the domain customer-defined parameter. The supplied domain name may be provided for a specified term through a lease agreement, and the lease price may be determined via auction or automatically by an algorithm based in whole or in part on static information and dynamic information regarding new domain name sales. The supplied domain name may be provided on a permanent basis through a sale, and the sale price may be determined via auction or automatically by an algorithm based in whole or in part on static information and dynamic information regarding new domain name sales.

The domain leasing system may be operated so that a characteristic of the Internet user relevant to the parameter is determined automatically and transparent to the Internet user based on the IP address of the Internet user's device or other identifying information. It may also be operated so that a characteristic of the Internet user relevant to the parameter is determined by an online prompt asking the Internet user to provide the relevant information to direct them to the appropriate domain customer.

The domain leasing system may be operated so that an Internet user falling within a domain customer's parameter is directed from the provided domain name to a unique domain name that can be accessed directly regardless of an Internet user's characteristics. That unique domain name may be generated for the domain customer or supplied by the domain customer. Alternately, a unique domain name may be generated and the originally provided domain name be displayed to the Internet user in the URL bar.

The provided domain names in the domain leasing system may be supplied by the provider of the system or supplied independently of the provider of the system, and if supplied independently, the system may operate the domain leasing system for the supplied domain name without the direct involvement of the domain owner. Irrespective of the provided domain name's source, the provided domain name may be hosted by the system's server, hosted by the domain customer's server, or hosted by a third-party server of the domain customer's choice. The provided domain name may be registered with the system domain name registry or registered with a third-party domain name registry. The provided domain name may be accessed by an Internet user via its Uniform Resource Locator (URL), via a search engine results page, via an online link, or via any other means of accessing an Internet website.

The network used to access the allocation server and the domain leasing system may be a wired (local area connection) network or a wireless (wide area connection) network, and the device used to access the network may be a computer, a mobile device, or any other device or means available to access the network.

The domain leasing system may be operated so that an Internet user that does not fall within the parameters of any domain customer is directed to generic content, directed to the website of the domain customer with the nearest adjacent parameter, directed to a website of an independent domain owner's choosing if the domain name is supplied independently of the provider of the system, or directed to other content. The domain customer for a provided domain name may elect whether to have Internet users not within their specified parameters directed to their site.

The domain leasing system may include functionality configured to include, on a plurality of domain sublease customer websites, a navigation element that allows Internet users to navigate away from that domain sublease customer's website. For example, an Internet user may wish to navigate away from the currently-presented website if a user determines that one of more characteristics should have directed him or her to the website of a different domain sublease customer associated with the same domain but defined by different parameters. In certain circumstances Internet users falling within the parameters of domain sublease customer A may be directed to the website of another domain sublease customer. Such circumstances include where an Internet user has previously made a prompted decision to prefer the website of a domain customer other than domain customer A on a continuous basis, where the website of domain customer A receives more Internet users at a given time than its allocated server capacity is capable of serving, where the website of domain customer A is not functioning due to domain customer A's actions, where domain customer A has failed to make agreed payments for use of the provided domain, or where domain customer A has failed to make agreed payments for use or receipt of services provided.

The domain leasing system allows for a domain customer to use multiple parameters to define the scope of their lease, and those chosen parameters may be mutually exclusive or partially overlapping, and the pricing of the leases may be adjusted to encourage the leasing of multiple parameters.

The domain leasing system is largely described herein with respect to Internet users accessing the network over an Internet protocol-based architecture using a means of browsing the Internet on a desktop, laptop, notebook or other computing device. The domain leasing system and allocation server may also be implemented using other networks, including variations on the existing IP-based architecture such as IPv6 and any other system that emerges as an organizing architecture for content on the Internet, wherein the allocation server is still capable to identify one or more characteristics of the Internet user accessing the network and route the Internet user to differentiated content based on one or more identifying characteristics. These alternate networks include the cellular networks, 3G, 4G and other networks that may be accessed using a device such as a smartphone, cellular phone, or other device capable of accessing content over a network.

The domain leasing system may also be used to generate leveraged online advertising campaigns based on the provided domain name. The online advertising campaigns may include search engine marketing, pay-per-click advertising, banner advertising, and any other online advertising method whereby Internet users access advertised content. In some embodiments, the advertising campaign can be automatically generated based on the contributions of the domain sublease customers for each domain name, and the benefits or click-throughs derived from the campaign can be directed, via the allocation server, based on the characteristics of the Internet user accessing the advertisement containing the provided domain name and the participation of the domain sublease customer for the provided domain name in the online advertising campaign. For example, 100 domain sublease customers in different geographies, each of whom has leased the domain “www.divorceattorney.com,” may contribute to a search engine marketing campaign based on the keywords “divorce attorney” and directed at the domain name “www.divorceattorney.com.” In such a scenario, when an Internet user clicks on the advertisement, the Internet user will be directed to the appropriate content for their geography, as long as the domain customer for their geography is a participant in the online advertising campaign. If the domain customer is not a participant, the Internet user may be routed to other content. If that Internet user were to click on a generic search result link for “www.divorceattorney.com,” they would be directed to the domain customer for their geographic area, regardless of that domain customer's participation in the search engine marketing campaign. The search engine marketing campaign and subsequent routing of traffic derived from the campaign would be generated via an algorithm that accounts for each domain customer's relative contribution to the campaign, the relative benefit each domain customer may derive based on the criteria defining the parameters of their lease, and any other relevant criteria useful to deliver an effective and fair advertising campaign that leverages individual domain customer contributions to create a broad-based campaign, the benefits of which then derive to each domain customer proportionally.

In an alternate embodiment of the invention, the parameter-based content delivery system may be used to enable multiple businesses or individuals to use the same domain name, simultaneously, for online marketing campaigns. These include search-engine marketing (SEM) campaigns and other similar web-based marketing campaigns run on different platforms utilizing a structure such as, pay-per-click, pay-per-action, cost-per-impression, and other online marketing campaign structures.

In this embodiment of the invention, a domain customer may lease the domain for exclusive or shared use with one or more online marketing methods. Instead of committing to leasing a single domain name across all marketing channels, as outlined above, a domain customer may wish to use multiple premium domain names, each for a specific purpose. Previously, local businesses were forced to use their existing, typically sub-par, domain name in all online marketing.

Some online marketing methods provide prominent placement to the domain name of the advertising site. An example would be a search-engine marketing program, which displays advertisements above or to the side of search results on a search engine results page. These advertisements generally contain a header, two lines of body text, and a URL. In this form of advertising, the URL plays an important role because it comprises approximately 25% of the total advertisement the Internet user sees. Incongruity between the URL and the rest of the advertisement may lead to user confusion and a decreased likelihood that the user will click on that advertisement. However, local businesses are often forced to use such misleading domain names in their marketing because they do not have the rights to a premium domain name that more directly corresponds to their business's offerings. This embodiment solves this problem by making premium domain names available to businesses and individuals for use in specific instances at affordable rates. Premium domain names not only reduce confusion for Internet users, but also benefit businesses by conferring credibility and driving increased click-through rates—which means more Internet users trust and thus click on the advertisement that is connected with the premium domain name.

One implementation of this embodiment of the invention is the use of a parameter-based domain name in conjunction with a specific search-engine marketing campaign. For example, a domain customer may utilize the domain leasing interface, as discussed in connection with FIG. 5, to choose a domain name appropriate for its search-engine marketing campaign. Thus, if the domain customer's existing domain name is “www.JohnsServiceTruck.com” and the business owner Customer Q is trying to market his window washing service via a search-engine marketing campaign where he stipulates for his ad to display when Internet users search for the keyword “window washing,” then he would benefit from choosing the domain name, “www.WindowWashing.com,” specifically for use with this SEM campaign. Customer Q would then have the rights to display www.WindowWashing.com in conjunction with his SEM advertisement. Customer Q would also be able to provide www.WindowWashing.com, an alternate sub-domain of www.WindowWashing.com, or some other variation of www.WindowWashing.com as the direct URL of the SEM advertisement, which may be required per the terms of service of certain SEM platforms. Instead of using the domain leasing process of FIG. 5, Customer Q may also select the domain name for the SEM, or similar, campaign during the process of setting up the SEM campaign. In this case, the domain subleasing process would be integrated with the SEM campaign set-up process, and the selected campaign would be associated with the domain sublease via user input—such as a user selection of a desired advertising campaign for association with the new domain sublease. Customer Q would select the copy for the ad header and body and be offered the option to choose a premium domain name for use with the instant SEM campaign. The use of the premium domain name may be incorporated in the base cost of the campaign, may be based on an additional percentage of the base cost of the ad campaign, may be based on a fixed cost per click, based on a fixed cost per specified time period, based on a sliding scale contingent on the volume of clicks and/or impressions, or based on some other means of pricing the additional service.

The provider of the domain sub-leasing system may use an algorithm, subjective check, or other means to confirm that Customer Q's website, or the website of any business using a leased domain name, is offering services or products that relate to the domain name they have elected to use, in order to ensure that Internet users are not misled and have an improved user experience.

Use of the subleased domain name by Customer Q may be limited exclusively to use in the specific marketing campaign for which the domain was leased. All Internet users that arrive at the subleased domain name of Customer Q via a means other than the specific marketing campaign may be displayed Customer Q's content, generic content, or some other content at the discretion of the provider of the domain sub-leasing system.

A domain that is used by a domain customer for a specific marketing campaign in a specific geographic area, or based on one or more other parameters, may still be made available for sub-leasing via the domain sub-leasing system in such a way that another business may select a sublease of that domain name, using the same criteria, so that the new domain customer will receive full access to that subleased domain at the expiration of the specific marketing campaign the other domain customer has in place.

What is claimed is:

1. A processor-readable medium storing code representing instructions configured to cause a processor to:
receive, from a requesting device, a website address;
receive a device identifier associated with the requesting device;
determine a geographic location associated with the requesting device, the determining being based at least in part on the device identifier;
identify a domain sublease record based at least in part on the geographic location and the website address; and
send, to the requesting device, a web content portion associated with the domain sublease record.

2. The processor-readable medium of claim 1, wherein the web content portion is a first web content portion, further storing code representing instructions configured to cause the processor to:
if the geographic location associated with the requesting device cannot be determined, send, to the requesting device, a second web content portion instead of the first web content portion.

3. The processor-readable medium of claim 2, wherein the second web content portion is associated with a generic link website.

4. The processor-readable medium of claim 1, wherein the domain sublease record is a first domain sublease record and the web content portion is a first web content portion, further storing code representing instructions configured to cause the processor to:
if a user preference entry associated with the device identifier and a second domain sublease record exists, send, to the requesting device, a second web content portion associated with the second domain sublease record instead of the first web content portion.

5. The processor-readable medium of claim 1, further storing code representing instructions configured to cause the processor to:
if the geographic location cannot be determined:
send, to the requesting device, a location prompt;
receive user-supplied geographic location information; and
determine the domain sublease record based at least in part on the user-supplied geographic location information and the website address.

6. The processor-readable medium of claim 1, wherein the determining the domain sublease record is further based at least in part on at least one geographic region parameter associated with the domain sublease record, the geographic location being physically located within a geographic region defined by the geographic region parameter.

7. The processor-readable medium of claim 1, wherein the identifying is further based at least in part on user demographic information, the user demographic information being determined based at least in part on the device identifier.

8. A processor-readable medium storing code representing instructions configured to cause a processor to:
receive, from a user, a domain identifier;
verify user ownership of the domain identifier;
receive, from the user, domain lease term information; and
define a domain lease record associated with the domain identifier and the user.

9. The processor-readable medium of claim 8, further storing code representing instructions configured to cause the processor to:
determine if the domain identifier is authorized, the determining being based at least in part on data stored in an authorization database;
receive remote host address information;
determine if the remote host address information is valid; and
define a remote hosting record that includes at least the remote host address information and the domain identifier.

10. The processor-readable medium of claim 8, further storing code representing instructions configured to cause the processor to:
receive a geographic parameter selection from the user; and
define a geographic parameter record associated with the domain identifier.

11. The processor-readable medium of claim 8, further storing code representing instructions configured to cause the processor to:
allocate a portion of a web content storage memory, the portion being associated with the domain identifier, a size of the portion being based at least in part on at least one of:
a geographic parameter associated with the domain identifier; and
a history of customer parameter selections for domain identifiers substantially similar to the domain identifier.

12. A processor-readable medium storing code representing instructions configured to cause a processor to:
receive, at a domain sublease system, a domain search query;
send one or more search results responsive to the domain search query, the one or more search results each including a domain identifier associated with a distinct domain;
receive, from a user, a domain identifier selection based on the one or more search results;
receive a customer parameter; and
define a domain sublease record based at least in part on the domain identifier selection, the customer parameter, and an identifier associated with the user.

13. The processor-readable medium of claim 12, further storing code representing instructions configured to cause the processor to:
receive, from the user, a domain sublease term selection; and
associate the domain sublease term selection with the domain sublease.

14. The processor-readable medium of claim 12, wherein the domain search query includes at least one of:
a domain keyword;
website visitor demographic information; and
website visitor geography information.

15. The processor-readable medium of claim 12, further storing code representing instructions configured to cause the processor to:
send at least one suggested domain identifier if the domain search query yields zero results, determination of the at least one suggested domain identifier being based at least in part on one or more of:
a first domain keyword similar to a second domain keyword included in the domain search query; and
a first geographic region physically adjacent to a second geographic region defined by a geographic parameter included in the domain search query.

16. The processor-readable medium of claim 12, wherein the customer parameter is at least one of:
a continent parameter;
a nation parameter;
a state parameter;
a designated metropolitan area (DMA) parameter;
a city parameter;
a zip code parameter;
a neighborhood parameter;
a building parameter;
an address parameter;
a transportation network parameter;
a latitude and/or longitude coordinate parameter;
an income parameter;
a family status parameter;
an education level parameter;
a language parameter;
a nationality parameter;
a race parameter; and
a religion parameter.

17. The processor-readable medium of claim 12, wherein the domain identifier selection is a first domain identifier selection and the customer parameter is a first customer parameter, further storing code representing instructions configured to cause the processor to:
if a domain sublease record associated with the first domain identifier selection and the first customer parameter already exists, send a prompt requesting at least one of:
a second customer parameter; and
a second domain identifier selection.

18. The processor-readable medium of claim 12, further storing code representing instructions configured to cause the processor to:
receive remote host address information;
determine if the remote host address information is valid; and
define a remote hosting record that includes at least the remote host address information and the domain identifier selection.

19. The processor-readable medium of claim 12, further storing code representing instructions configured to cause the processor to:
define an advertising campaign associated with the domain identifier;
define an advertisement associated with the advertising campaign, the advertisement configured to send a website address associated with the domain identifier when clicked;
receive, from a requesting device, the website address;
receive a device identifier associated with the requesting device;
determine a geographic location associated with the requesting device, the determining being based at least in part on the device identifier;
identify a domain sublease record based at least in part on the geographic location and the website address, the domain sublease record being associated with the domain identifier and the advertising campaign;
send, to the requesting device, a web content portion associated with the domain sublease record; and
define an advertising campaign credit associated with the domain sublease record.

20. The processor-readable medium of claim 12, further storing code representing instructions configured to cause the processor to:
receive an advertising campaign selection; and
associate the domain sublease record with an advertising campaign, the associating being based at least in part on the advertising campaign selection.
